(19) United States
(12) Patent Application Publication
(10) Pub. No.: US 2011/0068500 A1
(43) Pub. Date: Mar. 24, 2011

(54) MOLD DESIGN AND POWDER MOLDING PROCESS

(75) Inventors: ANDREW JAMES MARTIN, INDIANAPOLIS, IN (US); HENGDA DEREK LIU, WARSAW, IN (US); JUWAN RIM, WARSAW, IN (US); JEFFREY A. RYBOLT, FORT WAYNE, IN (US)

(73) Assignee: DEPUY PRODUCTS, Inc., WARSAW, IN (US)

(21) Appl. No.: 12/877,322

(22) Filed: Sep. 8, 2010

Related U.S. Application Data
(60) Provisional application No. 61/240,828, filed on Sep. 9, 2009.

(51) Int. Cl. B29C 43/10; B22F 3/03

(52) U.S. Cl. 264/109; 425/78

(57) ABSTRACT

Provided are molds comprising a substantially concave portion, and a cap portion that is configured for removable attachment to the substantially concave portion and comprises a mandrel formed from a substantially rigid material, wherein the cap portion and the substantially concave portion, when attached, define an internal space having a three-dimensional shape. Among other benefits, the disclosed devices and methods of using such devices provide more uniform and repeatable compaction than conventional molds, and can be used to produce compacted structures having more dimensionally accurate and repeatable surface features, thereby yielding a better, more optimal near net shaped part.

### CROSS REFERENCE TO RELATED APPLICATION

This application claims priority to U.S. Provisional Application No. 61/240,828, filed Sep. 9, 2009, which is incorporated herein by reference in its entirety.

### TECHNICAL FIELD

The present invention relates to, among other things, methods and devices for the preparation of porous metal constructs.

### BACKGROUND

Cold isostatic pressing is an effective way to prepare near net shaped powder compacts. The process involves filling molds with powders, and placing the filled molds in a pressure vessel that is used to compress the powder into a compacted mass (green body). A cold isostatic press is often used to compress powder mixtures of metal and space filler, wherein the latter is removed following compaction to obtain a metal structure having pores. Porous metal constructs are widely used as, among other things, orthopedic implants, supports for catalysts, bone growth substrates, and filters.

Traditional methods of preparing powder compacts have involved the filling of an assembled mold, the interior space of which substantially corresponds to the shape of the green body that results from compacting the powder with which the mold is filled. The assembled molds are filled by pouring the metallic powder or powder mixture through a small opening in the mold that is subsequently plugged prior to compaction. For example, a mold that is designed for preparing a metal construct in the form of an acetabular cup typically features an end cap and a dome, wherein the peak of the dome includes a hole into which a powder may be poured in order to fill the mold. After filling, a plug is used to seal the mold before compaction commences.

However, conventional molds of this variety can produce unsatisfactory results in a number of respects. For example, there is often dimensional variability among the green bodies that are produced by subjecting the filled molds to pressure; in the case of cup-shaped molds, for example, the inner and outer radii of the cup can respectively vary from green body to green body.

Another problem is that filling the mold through a small hole and using a plug to seal the mold can result in an imperfection in the resulting green body at the location of the plugged opening.

The process of filling such molds is also difficult and time-consuming to perform. Typically, after the mold is filled through the opening with as much powder as possible, the mold is closed and tapped against a hard surface in order to cause the powder to settle as much as possible. The fill hole so that more powder can be introduced; this process is repeated until the mold is as completely filled as possible. Aside from being bothersome and protracted, the filling process can result in powder spillage, which causes waste and risks the possibility of exposure of personnel to escaped powder. In addition, despite such efforts, the process often results in an imperfectly filled mold.

Overfilling of the mold with powder can cause the formation of gaps between parts of the mold. Compaction of a filled mold may involve the use of water as a compression medium, leading to leakage of water, especially when the mold has been overfilled. Such leakage can lead to failure in attempts to form a compacted body.

A further problem with conventional molds is that repeated usage often causes wear on the mandrel section of the end cap relative to the other portions of the mold. If the shape of the mandrel is altered as a result of wear, the green body that is produced in the worn mold can deviate from the desired shape. Excessive wearing of the mandrel can also lead to cracking and splitting on that part of the mold.

There exists a need for molds that are designed to overcome some or all of such problems and that are capable of endowing the compaction process with uniformity and repeatability.

### SUMMARY

In one aspect, the present invention provides molds that comprise a substantially concave portion, and a cap portion that is configured for removable attachment to the substantially concave portion, wherein the cap portion and the substantially concave portion, when attached, define an internal space having a three-dimensional shape, and wherein the cap portion comprises a mandrel that is formed from a substantially rigid material and is disposed on a surface of the cap portion defining the internal space.

In another aspect, the present invention discloses methods comprising providing a mold that comprises a substantially concave portion and a cap portion that is configured for removable attachment to the substantially concave portion, placing metal powder into the substantially concave portion, and attaching the cap portion to the substantially concave portion following the placement of the metal powder therein.

Also provided are methods comprising placing a metal powder into a substantially concave portion of a mold, wherein the mold further comprises a cap portion that is configured for removable attachment to the substantially concave portion and comprises a mandrel formed from a substantially rigid material, and compacting the mold to form a green body comprising the metal powder.

### BRIEF DESCRIPTION OF THE DRAWINGS

FIG. 1 depicts a mold assembly in accordance with the prior art.

FIG. 2 provides perspective and cross-sectional views of an end cap according to the present invention.

FIG. 3A depicts an exemplary substantially concave portion that is filled with powder while separated from an end cap; FIG. 3B illustrates how the end cap of FIG. 3A is joined to the substantially concave portion after the powder has been placed into the substantially concave portion.

FIG. 4 provides photographic images of green bodies that were respectively prepared using a conventional mold and a mold in accordance with the present invention.

FIG. 5 provides dimension measurements of the green state parts that result from the use of conventional and inventive molds, respectively.

FIG. 6 includes photographic images of green bodies that were respectively prepared using a conventional mold and a mold in accordance with the present invention.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of the claimed invention.

In the present disclosure the singular forms “a,” “an,” and “the” include the plural reference, and reference to a particular numerical value includes at least that particular value, unless the context clearly indicates otherwise. Thus, for example, a reference to “a powder” is a reference to one or more of such powders and equivalents thereof known to those skilled in the art, and so forth. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive; as another example, the phrase “about 8%” preferably refers to a value of 7.2% to 8.8%, inclusive (rounded to the nearest integer in cases where integral quantities are considered). Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.”

The disclosures of each patent, patent application, and publication cited or described in this document are hereby incorporated herein by reference, in their entirety.

Unless otherwise specified, the characteristics of the components or steps that are described with respect to one embodiment of the present disclosure are applicable to the components or steps of other embodiments of the present disclosure.

The present invention provides, among other things, devices and methods for the preparation of structures comprising compacted particles, such as green bodies that are prepared from powders, including metallic powders. The disclosed methods and devices typically provide more uniform and repeatable compaction than conventional molds, and can be used to produce, for example, compacted structures having more dimensionally accurate and repeatable surface features, thereby yielding a better, more optimal near net shaped part. In addition, the present disclosure provides methods and devices that in certain embodiments are compatible with rapid and consistent filling of molds with powders. These advantages and others will become more readily apparent from the detailed description provided below.

In one aspect, the present invention provides molds that comprise a substantially concave portion, and a cap portion that is configured for removable attachment to the substantially concave portion, wherein the cap portion and the substantially concave portion, when attached, define an internal space having a three-dimensional shape, and wherein the cap portion comprises a mandrel that is formed from a substantially rigid material and is disposed on a surface of the cap portion defining the internal space.

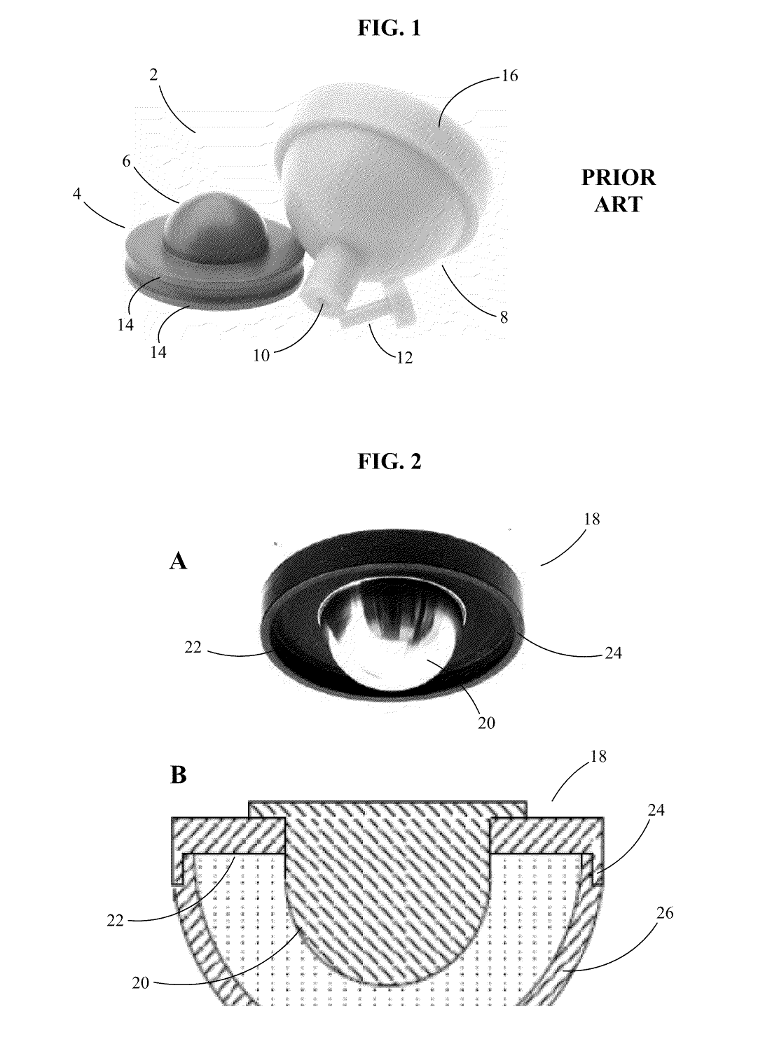

A cold isostatic press is often used to compact powders or powder mixtures, including metal powders, in conventional molds. A disassembled view of a conventional mold 2 is depicted in FIG. 1. Such molds are typically made from rubber and can comprise an end cap 4 having a mandrel 6, and a main body 8 that includes an opening 10 into which the powder or powder mixture is poured in order to fill the mold when the main body 8 and end cap 4 are assembled into the mold 2. To assemble the mold, the main body 8 is secured over end cap 4, with the mandrel 6 positioned within the internal space of mold 2. Ribs 14 on the outer edge of end cap 4 form a seal with the inner face of the end 16 of main body 8. After the assembled mold is filled, opening 10 is sealed using a plug 12 prior to compaction of the filled mold 2.

There is often some dimensional variability among compacted parts that are made with conventional molds, due in part to the flexibility of the material of which the mold is made. However, it has presently been discovered that incorporating a mandrel that is formed from a substantially rigid material into the end cap of a mold significantly improves the repeatability of the compression process, allowing for the preparation of precisely and accurately shaped compressed parts with each use of the inventive mold. This repeatability also provides a basis for accurate machining of the compressed part (green body); in the absence of such repeatability, it is difficult to position the green body for accurate machining and thereby to produce precisely formed end parts. In addition, to the extent that the green bodies that are produced using the inventive molds more reliably approximate the shape of the internal space defined by the parts of the assembled mold, less machining is necessary, which conserves time and energy, and also reduces powder wastage.

The inclusion of a mandrel that is formed from a substantially rigid material also assists the mold in resisting wear. Conventional molds deteriorate after repeated use, and the present inventors have discovered that splitting and cracking of flexible mandrels occurs long before any perceptible wear appears on the mandrels of the inventive molds. Therefore, the use of a mandrel that is formed from a substantially rigid material can improve mold life, which is important because a worn mold can admit water during a cold isostatic press procedure. Leakage of water into the mold can damage or destroy the part, and can cause powder to enter the pressure chamber. The present molds in many instances can therefore increase mold life, decrease the incidence of wasted parts, and improve the safety of the process of preparing green bodies from powder materials.

It has also been discovered that the present molds can often produce green bodies from powder mixtures with reduced segregation among different particle types. Such results are described in Example 2, below. Evenness of particle dispersion provides for more uniform porosity in the finished construct, as well as enhanced uniformity with respect to other structural attributes.

The internal space of the assembled molds may define any three dimensional shape, and preferably defines a three dimensional shape that substantially corresponds to the shape of a medical implant, catalyst, or other structure that is to be prepared from the green body. For example, the three dimensional shape of the internal space that is defined by the assembled mold may have a substantially hollow, hemispherical shape. Molds having an internal space that have a substantially hollow, hemispherical shape may be used to form green bodies that can, in turn, be made into acetabular cup orthopedic implants.

The present molds may be filled in accordance with conventional techniques, i.e., by pouring a fill material, such as a metal powder or mixture of powders, into an opening in the assembled mold. For example, the substantially concave portion may comprise an opening that is configured for receiving a metal powder for filling the mold. Once the mold has been filled, the opening may be plugged prior to compaction. In other embodiments, the substantially concave portion does not include an opening, and the mold is not filled in the assembled state. Such embodiments are more fully described infra.

The cap portion comprises a mandrel that is formed from a substantially rigid material. The substantially rigid material may be any substance or mixture of substances that render the mandrel more rigid than a conventional flexible mandrel (for example, a rubber mandrel). Preferably, the mandrel may comprise any material that can withstand pressures of about 20 to about 60 ksi with limited deformation. As used herein “limited deformation” preferably refers to deformation that is less than about 0.5%, less then about 0.3%, less than about 0.2%, or less than about 0.1%. The substantially rigid material may be, for example, a metal, a metal alloy, a ceramic or a synthetic polymer. Nonlimiting examples of suitable polymers include polypropylene, polyetheretherketone, polyphenylsulfone, polyetherimide and their carbon-fiber reinforced or glass-fiber reinforced counterparts. Nonlimiting examples of suitable metals include stainless steel, carbon steel, alloy steel, titanium, a titanium alloy (e.g., Ti-6Al-4V), a cobalt-chromium alloy, aluminum or an aluminum alloy, molybdenum, tantalum, niobium, zirconium, tungsten, or any combination thereof. Nonlimiting examples of suitable ceramics include alumina, zirconia, carbides, nitrides, borides, and silicides. The mandrel may be any three dimensional geometric or irregular shape. For example, the mandrel may be substantially hemispherical, substantially cube shaped, substantially cone shaped, substantially pyramidal, substantially cylindrical, or shaped like another regular or irregular three dimensional geometric object.

The end cap may include one or more aspects that are substantially concave. However, in many embodiments the substantially concave portion of the presently disclosed molds is configured such that it would hold a greater volume of fill material than the end cap if the volumetric capacities of the respective parts were compared. The substantially concave portion may be hemispherical. For example, the substantially concave portion may literally be a hemisphere (a half-sphere), or may be a lesser or greater portion of a sphere or other spheroidal body such as an ovoid. In other embodiments, the substantially concave portion may be a three dimensional object, such as a polyhedron. Thus, the substantially concave portion may be substantially cube shaped, substantially rectangular prismatic, substantially cylindrical, substantially cone shaped, substantially pyramidal, or shaped like another regular or irregular three dimensional geometric object.

The substantially concave portion may be formed from flexible material. In these and other embodiments, the cap portion may comprise flexible material that is fixedly attached to the mandrel. When the cap portion comprises flexible material that is fixedly attached to the mandrel, the flexible material may comprise a ring that is fixedly attached to an outer edge of the mandrel. Because the outer edge of the mandrel may be any shape (depending on the shape of the mandrel itself), a “ring” may refer to any shape having an inner edge that substantially conforms to the shape of the outer edge of the mandrel, and having an outer edge that substantially conforms to the shape of the inner or outer edge of the substantially concave portion. As used herein, a “flexible” material is one that is pliable relative to a substantially rigid material such as steel. Conventional mold components are often rubber, and the substantially concave portion, the part of the cap portion that is fixedly attached to the mandrel, or both, may be conventional rubber (natural or synthetic) or another material having similar properties. Other possible materials include, inter alia, polyisoprene, neoprene, chloroprene, silicone, polyvinyl chloride (PVC), nitrile, vinyl acetate, ethylene propylene diene M-class rubber (EPDM), fluoronated hydrocarbon or Viton® fluoroelastomer (DuPont Performance Elastomers, Wilmington, Del.), crosslinked polyethylene (XLPE), butyl rubber, fluorosilicone rubber, polyurethane, and the like. The physical dimensions of the flexible material of the substantially concave portion and of the cap portion may each vary as dictated by the particular requirements of the user. For example, the flexible material of the substantially concave portion and of the cap portion independently can be between about 0.03 and about 0.50 inches thick. In other embodiments, the thickness of the flexible material of either component can be between about 0.05 and about 0.30 inches, between about 0.10 and about 0.20 inches, or about 0.125 inches.

The cap portion of the present molds is configured for removable attachment to the substantially concave portion and comprises a mandrel formed from a substantially rigid material. The configuration of the cap portion so that it can be removably attached to the substantially concave portion may be in accordance with conventional designs, with which those of ordinary skill in the art are familiar. FIG. 1 depicts a conventional end cap 4, which includes ribs 14 that form a seal with the inner face of the end 16 of main body 8 when mold 2 is in its assembled state. In other embodiments, the perimeter of the cap portion may comprise a lip that seals against the outer edge of the substantially concave portion. FIG. 2A shows an exemplary end cap 18 according to the present invention. End cap 18 comprises a mandrel 20 that comprises a substantially rigid material, and a ring 22 of flexible material that is fixedly attached to the outer edge of the mandrel 20. FIG. 2B provides a cross sectional view of the end cap 18 shown in FIG. 2A, wherein end cap 18 is removably attached to an exemplary substantially concave portion 26 in accordance with the present invention. At its outermost edge, ring 22 of flexible material terminates in a lip 24 that is configured for removable attachment to the outer edge of one end of the substantially concave portion 26. In this manner, the end cap 18 is interlocked with the substantially concave portion 26 in such a manner as to form a secure seal between the components of the mold. The removable fixation of end cap 18 via lip 24, or by other means in accordance with other embodiments, provides a seal that, among other things, prevents water from entering the mold during the compaction process and prevents powder from escaping from the internal space of the mold into the compression chamber. The removable fixation of the end cap to the substantially concave portion may be achieved in any appropriate manner, such as by providing any suitable overlap or interlock therebetween.

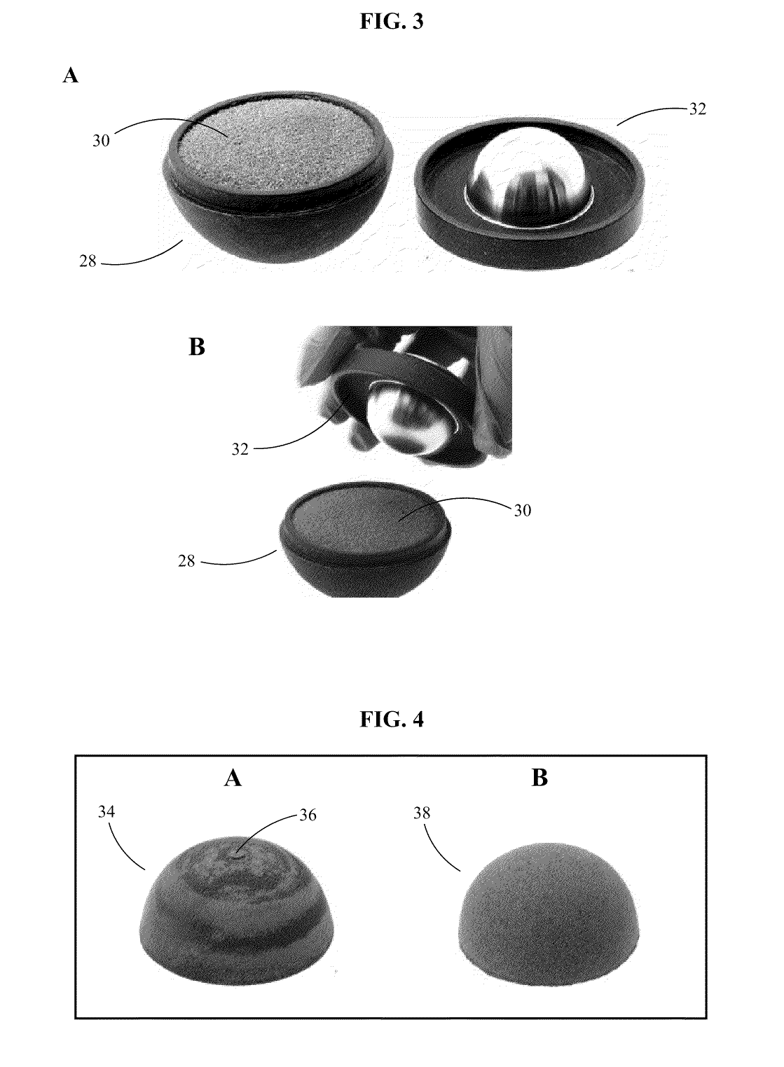

In another aspect, the present invention provides methods comprising providing a mold that comprises a substantially concave portion and a cap portion that is configured for removable attachment to the substantially concave portion, placing metal powder into the substantially concave portion; and attaching the cap portion to the substantially concave portion following the placement of the metal powder therein. Such methods employ a particular embodiment of the inventive molds described above, in which the substantially concave portion does not include an opening, and the mold is not filled in the assembled state. Rather, the mold is filled by placing metal powder into the substantially concave portion prior to attachment to the end portion. In accordance with such methods, a desired quantity of metal powder (in particular, an amount that is known to precisely fill the mold) is determined by weight, i.e., by weighing out the powder on a suitable instrument, such as a laboratory scale. When the desired quantity of powder has been obtained, the powder is placed into the substantially concave portion. FIG. 3A depicts an exemplary substantially concave portion 28 that is filled with powder 30 while separated from an end cap 32. As shown in FIG. 3B, when the powder 30 has been placed into the substantially concave portion 28, end cap 32 is joined to the substantially concave portion 28, whereupon powder 30 is housed within the mold. The use of a precise amount of powder that is suitable for use in the substantially concave portion precludes a situation whereby too much powder (i.e., overfilling of the mold, which can make it difficult to assemble the mold properly and/or can cause the parts of the mold to separate during compression) or too little powder (i.e., underfilling of the mold, which can prevent the resulting green body from having the proper shape) is placed in the substantially concave powder. The present methods may further comprise compacting the mold to form a green body comprising the metal powder. The ability to place a desired quantity of powder into the substantially concave portion prior to assembly of the mold ensures a higher degree of consistency among the green bodies that are formed by compacting the assembled mold, enables the creation of a more near net shaped part, and improves the process of machining.

Also disclosed are methods comprising placing a metal powder into a substantially concave portion of a mold, wherein the mold further comprises a cap portion that is configured for removable attachment to the substantially concave portion and comprises a mandrel formed from a substantially rigid material, and compacting said mold to form a green body comprising the metal powder. In accordance with such methods, the metal powder may be placed into the substantially concave portion of the mold prior to attachment of the cap portion to the substantially concave portion. In such embodiments, the present methods may further comprise attaching the cap portion to the substantially concave portion prior to compacting the mold. In other embodiments, the metal powder is placed into the substantially concave portion of the mold while the cap portion is attached to substantially concave portion. For example, the metal powder may placed into the substantially concave portion of the mold through an opening in the substantially concave portion. After the metal powder is placed into the mold, the opening in the substantially concave portion may be closed, e.g., using a plug, and remains closed during compaction of the filled mold in order to form a green body.

With respect to any of the methods disclosed herein, the metal powder may comprise one or more metals, optionally in combination with an extractable material. The extractable material may be included in order to form a porous construct pursuant to the “space holder” method. The space holder method is a well known process for making metallic foam structures and employs dissolvable or otherwise removable space-holding materials that are combined with metallic powders and subsequently removed from the combination by various methods, including heat or liquid dissolution, leaving behind a porous matrix formed from the metallic powder. The porous matrix material is then sintered to further strengthen the matrix structure. Numerous variations on the space holder concept are known in the art. See, e.g., U.S. Pat. Nos. 3,852,045; 6,849,230; U.S. Pub. Nos. 2005/0249625; 2006/0002810.

The metal powder, and by extension the resulting green body and porous construct, may comprise any biocompatible metal, nonlimiting examples of which include titanium, a titanium alloy (e.g., Ti-6Al-4V), a cobalt-chromium alloy, aluminum, molybdenum, tantalum, magnesium, niobium, zirconium, stainless steel, nickel, tungsten, or any combination thereof. In accordance with known methods for forming green bodies and porous constructs using metal powders, it will be readily appreciated that the metal powder particles may be substantially uniform or may constitute a variety of shapes and sizes, e.g., may vary in terms of their three-dimensional configuration and/or may vary in terms of their respective major dimension. Measured with respect to a given particle's major dimension, particle size may be from about 20 μm to about 100 μm, from about 25 μm to about 50 μm, or from about 50 μm to about 80 μm. The metal powder particles may be spheroids, roughly cylindrical, platonic solids, polyhedrons, plate- or tile-shaped, irregularly shaped, or any combination thereof. In preferred embodiments, the metal powder comprises particles that are substantially similarly shaped and substantially similarly sized.

The extractable material may be a material that is soluble in an aqueous fluid, an organic solvent, a combination of such solvents, or any other suitable solvent. The material may comprise a salt, a sugar, a solid hydrocarbon, a urea derivative, a polymer, or any combination thereof. Nonlimiting examples include ammonium bicarbonate, urea, biuret, melamine, ammonium carbonate, naphthalene, sodium bicarbonate, sodium chloride, ammonium chloride, calcium chloride, magnesium chloride, aluminum chloride, potassium chloride, nickel chloride, zinc chloride, ammonium bicarbonate, sodium hydrogen phosphate, sodium dihydrogen phosphate, potassium dihydrogen phosphate, potassium hydrogen phosphate, potassium hydrogen phosphite, potassium phosphate, magnesium sulfate, potassium sulfate, alkaline earth metal halides, crystalline carbohydrates (including sucrose and lactose or other materials classified as monosaccharides, disaccharides, or trisaccharides), polyvinyl alcohol, polyethylene oxide, a polypropylene wax (such those available from Micro Powders, Inc., Tarrytown, N.Y., under the PROPYLTEX® trademark), sodium carboxymethyl cellulose (SCMC), or any combination thereof. Alternatively or additionally, the extractable material may be removed under heat and/or pressure conditions; for example, the extractable material may volatilize, melt, or otherwise dissipate as a result of heating. Examples of such extractable materials include ammonium bicarbonate, urea, biuret, melamine, ammonium carbonate, naphthalene, sodium bicarbonate, and any combination thereof.

When the extractable material comprises particles, such particles may be substantially uniform with respect to one another or may constitute a variety of shapes and sizes, e.g., may vary in terms of their three-dimensional configuration and/or may vary in terms of their respective major dimension. The extractable material can be present in a wide variety of particle sizes and particle size distributions suitable to produce a desired pore size and pore size distribution. Certain preferred particle size ranges are from about 200 μm to about 600 μm, from about 200 μm to about 300 μm, and from about 425 μm to about 600 μm. The extractable material particles may be spheroids, roughly cylindrical, platonic solids, polyhedrons, plate- or tile-shaped, irregularly shaped, or any combination thereof. In preferred embodiments, the space filler comprises particles that are substantially similarly shaped and substantially similarly sized. Because the size and shape of the pores of the porous construct that is eventually produced from the mixture of the metal powder and the extractable material roughly correspond to the size and shape of the particles of the extractable material, one skilled in the art will readily appreciate that the characteristics of the particles of the extractable material may be selected according to the desired configuration of the pores of the resulting porous product. In accordance with the present invention, when the extractable material comprises particles that are substantially similarly shaped and substantially similarly sized, the porosity of a porous construct that is eventually formed using the extractable material of this type will be substantially uniform.

A powder mixture may comprise metal powder in an amount that is about 5 percent by volume to about 45 percent by volume, preferably about 15 percent by volume to about 40 percent by volume, the balance of the powder mixture comprising the extractable material. Once the extractable material is removed from the green body that is formed from the mixture of the metal powder and extractable material in later stages of the present methods, the resulting porosity of the green body may be about 55% to about 95%, preferably about 60% to about 85%. The powder mixture of which the green body is made may comprise about 18 wt. % to about 67 wt. % metal powder, the balance of the powder mixture comprising the extractable material.

Suitable techniques for mixing a metal powder with an extractable material will be readily appreciated by those skilled in the art. See, e.g., U.S. Pat. Nos. 3,852,045, 6,849,230; U.S. Pub. Nos. 2005/0249625, 2006/0002810. Ideally, the mixing results in a substantially uniform dispersion of the particles comprising the minor component of the powder mixture among the particles comprising the major part of the powder mixture. The metal powder may comprise about 18 to about 67 weight percent of the powder mixture, the balance of the powder mixture comprising the extractable material. Once the extractable material is removed from the green body in later stages of the present methods, the resulting porosity of the green body may be about 50% to about 90%, preferably about 60% to about 85%. The removal of the extractable material is described more fully in PCT/US2009/044970, filed May 22, 2009, and U.S. Ser. No. 12/470,397, filed May 21, 2009, both of which are incorporated by reference in their entirety.

In some embodiments, the mold need not be designed to produce near-net shape parts or parts whose molded form resembles the desired final, sintered part; molds may produce generic shapes, such as bars, rods, plates, or blocks, that may be subsequently machined in the green state to produce a part that after sintering-induced shrinkage closely approximates the desired shape of the final product, with optional machining of the sintered part. Molds and mold assemblies for such purposes are well known among those skilled the art and may allow for the preparation of bodies that are, for example, spherical, spheroid, ovoid, hemispherical, cuboid, cylindrical, toriod, conical, concave hemispherical (i.e., cup-shaped), irregular, or that adopt any other desired three-dimensional conformation. Once formed from the powder or powder mixture in accordance with the preceding, the resulting shaped object may be compacted to form the green body. The shaped object is compacted while contained within a mold assembly. Compacting may be uniaxial, multi-axial, or isostatic. In preferred embodiments, a cold isostatic press is used to compact the powder into the green body. Following the compacting procedure, the resulting green body may be removed from the mold and may be processed. Processing may include machining or otherwise refining the shape of the green body.

### Example 1

### Acetabular Cup

Green bodies for forming acetabular cup orthopedic devices were made from a conventional mold and from a mold in accordance with the present invention. The conventional mold included an end cap 4 and substantially concave portion 8 as depicted in FIG. 1. The inventive mold included an end cap 18 as shown in FIG. 2A, including a mandrel 20 that comprises a substantially rigid material, and a ring 22 of flexible material that is fixedly attached to the outer edge of the mandrel 20. The inventive mold also included a substantially concave portion 28 as shown in FIG. 3A.

The conventional mold was filled affixing end cap 4 to substantially concave portion 8, and by pouring a metal powder comprising titanium or titanium alloy mixed with extractable material into the opening 10 of the substantially concave portion 8. Because the opening 10 was confined and small, a funnel was used to pour the powder into the mold. Even with the use of a funnel, some air remained within the mold during the filling process. In order to fill up the mold as completely as possible with the mixed powder, multiple steps were performed during which time the mold was shaken or vibrated repeatedly during pauses between bouts of scoop feeding the powder into the mold. The opening 10 was then sealed using a stopper 12, and the mold was placed into the compression chamber of the pressure vessel (Cold Isostatic Press, CIP42260, Avure Autoclave Systems, Inc., Kent, Wash.), which was filled with water as the pressure medium. The pressure vessel was closed in accordance with standard procedure, and the contents of the vessel, including the mold, were subjected to cold isostatic pressing at a pressure of 45 ksi for about 15 seconds. The pressure vessel was then opened and the mold was removed. The mold was then disassembled and the compacted metal part was extracted.

The inventive mold was filled by weighing out, for example, 131.9 g of a metal powder comprising titanium mixed with sodium chloride on an electronic scale (XS16001L Precision Balance, Mettler-Toledo, Inc., Columbus, Ohio), and pouring the weighed aliquot of metal powder into substantially concave portion 28. The mold was closed by affixing end cap 18 to the substantially concave portion 28. The inventive mold was placed into the compression chamber of the pressure vessel (Cold Isostatic Press, CIP42260, Avure Autoclave Systems, Inc., Kent, Wash.) which was filled with water as the pressure medium. The pressure vessel was closed in accordance with standard procedure, and the contents of the vessel, including the inventive mold, were subjected to cold isostatic pressing at a pressure of 45 ksi for about 15 seconds. The pressure vessel was then opened and the inventive mold was removed. The mold was then disassembled and the compacted metal part was extracted.

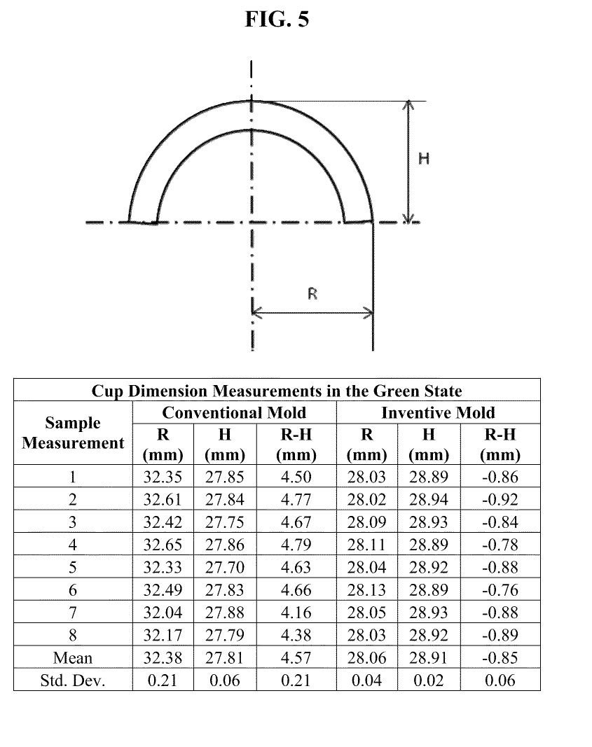

FIG. 4A depicts a photographic image of the green body 34 that was removed from the conventional mold, while FIG. 4B provides a photographic image of the green body 38 that was removed from the inventive mold. A visual analysis of the compacted parts reveals that green body 34 was not a true hemisphere, and the dispersion of particles therein was non-uniform. Because a conventional mold possessed a small, confined opening, it was necessary to fill the mold scoop by scoop in small amounts, which became progressively more difficult as the mold became closer to being filled to capacity: the mold must be shaken, vibrated or pounded on a counter during filling, which resulted in the drying and segregation of the powder mixture as between the metal particles and space holder material. In FIG. 4A, the darker bands on green body 34 are indicative of portions that contain a higher proportion of metal powder relative to space holder material, and lighter bands indicate portions that have a higher proportion of space filler material relative to metal powder. In addition, green body 34 included a blemish 36 that corresponds to the location of the opening in the substantially concave portion that receives the metal powder during the filling of the mold. In contrast, green body 38 more closely approximated a true hemisphere, featured uniform particle dispersion, and had a substantially smooth surface profile. Cup dimension measurements of the green state parts that result from the use of conventional and inventive molds, respectively, are shown in FIG. 5. Standard deviation values were greater for the green bodies prepared using conventional molds than those prepared using molds according to the present invention. In addition, with respect to the cups that were prepared using the inventive molds, the variation between the “R” and “H” radius values (expressed as “R−H”) was considerably less than that which was measured with respect to the cups that were prepared using conventional molds. This indicates that the use of the present molds allows for the preparation of green bodies that come much closer to resembling a true approximation of the mold shape than do the green bodies made using conventional molds.

### Example 2

### Repeatability

The inventive molds were tested for the ability to consistently produce green bodies having a predictable shape and particle dispersion. A single inventive mold for an acetabular cup was filled and subjected to compaction in accordance with the conditions described in Example 1, above, and this process was repeated three times in order to obtain three separate green bodies. The green bodies were compared by visual inspection and physical measurement. It was found that the green bodies that were produced using the inventive mold were of substantially uniform shape and did not include blemishes or other physical discrepancies that would be expected among green bodies that are produced using conventional molds. Table 1, below, provides data demonstrating that the standard deviations among the R, H, and R−H values that are measured with respect to green bodies that are produced using the inventive molds (0.020, 0.23, and 0.26, respectively) are less than those which are measured with respect to green bodies that are produced using conventional molds (0.31, 0.94, and 0.90, respectively).

TABLE 1

| | | Conventional Mold | | | Inventive Mold | | |
|---|---|---|---|---|---|---|---|
| Sample | | R | H | R-H | R | H | R-H |
| Number | Measurement | (mm) | (mm) | (mm) | (mm) | (mm) | (mm) |
| 1 | 1 | 32.02 | 26.86 | 5.16 | 37.20 | 36.82 | 0.38 |
| | 2 | 32.45 | 26.73 | 5.72 | 37.03 | 36.42 | 0.61 |
| | 3 | 31.48 | 27.05 | 4.43 | 37.39 | 37.13 | 0.26 |
| | 4 | 32.05 | 27.47 | 4.58 | 37.35 | 36.83 | 0.52 |
| 2 | 1 | 32.11 | 29.07 | 3.04 | 37.65 | 36.97 | 0.68 |
| | 2 | 32.56 | 29.06 | 3.50 | 37.51 | 36.45 | 1.06 |
| | 3 | 32.02 | 29.40 | 2.62 | 37.50 | 36.42 | 1.08 |
| | 4 | 32.17 | 29.06 | 3.11 | 37.55 | 36.74 | 0.81 |
| 3 | 1 | 31.95 | 28.32 | 3.63 | 37.16 | 36.72 | 0.44 |
| | 2 | 32.53 | 28.50 | 4.03 | 37.53 | 36.83 | 0.70 |
| | 3 | 31.93 | 28.37 | 3.56 | 37.61 | 36.74 | 0.87 |
| | 4 | 32.39 | 28.52 | 3.87 | 37.54 | 36.96 | 0.58 |

| | | | | | | |
|---|---|---|---|---|---|---|
| Mean | 32.14 | 28.20 | 3.94 | 37.42 | 36.75 | 0.67 |
| Std. Dev. | 0.31 | 0.94 | 0.90 | 0.20 | 0.23 | 0.26 |

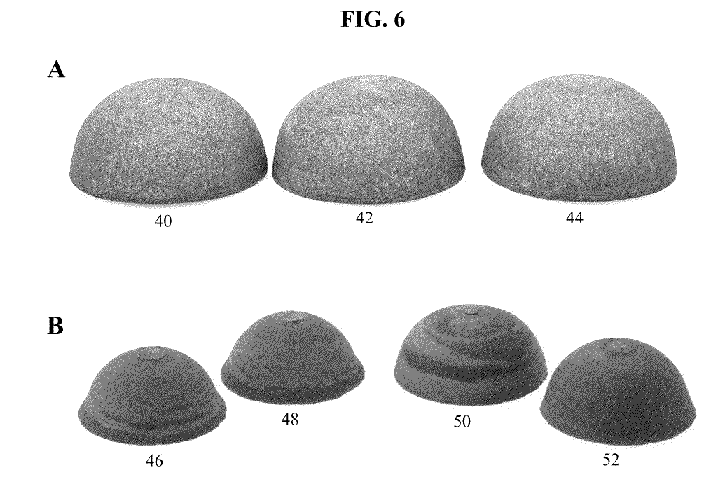

FIG. 6A depicts images of green bodies 40, 42, 44 that were produced using inventive molds. Like the green body shown in FIG. 4B, green bodies 40, 42, 44 approximated a true hemisphere, featured uniform particle dispersion, and had a substantially smooth surface profile. FIG. 6A also demonstrates that the molds of the present invention produce green bodies that are of substantially uniform shape from green body to green body, and that do not include blemishes or other physical discrepancies that would be expected among green bodies that are produced using conventional molds. In comparison, FIG. 6B shows that green bodies 46, 48, 50, 52 that were produced using conventional molds varied from one another with respect to the parameters of shape, surface profile, and particle dispersion.

What is claimed:

1. A mold comprising:
a substantially concave portion; and,
a cap portion that is configured for removable attachment to said substantially concave portion,
wherein said cap portion and said substantially concave portion, when attached, define an internal space having a three-dimensional shape, and wherein said cap portion comprises a mandrel that is formed from a substantially rigid material and is disposed on a surface of said cap portion defining said internal space.

2. The mold according to claim 1 wherein said substantially concave portion comprises an opening that is configured for receiving a metal powder.

3. The mold according to claim 1 wherein said substantially concave portion is hemispherical.

4. The mold according to claim 3 wherein said cap portion and said substantially concave portion, when attached, define an internal space having a substantially hollow hemispherical shape.

5. The mold according to claim 1 wherein said substantially concave portion is formed from a flexible material.

6. The mold according to claim 1 wherein said substantially rigid material comprises metal.

7. The mold according to claim 1 wherein said cap portion comprises flexible material that is fixedly attached to said mandrel.

8. The mold according to claim 7 wherein said flexible material of said cap portion comprises a ring that is fixedly attached to an outer circumference of said mandrel.

9. A method comprising:
providing a mold that comprises a substantially concave portion and a cap portion that is configured for removable attachment to said substantially concave portion,
placing metal powder into said substantially concave portion; and
attaching said cap portion to said substantially concave portion following said placement of said metal powder therein.

10. The method according to claim 9 wherein said cap portion and said substantially concave portion, when attached, define an internal space having a three-dimensional shape.

11. The method according to claim 10 wherein said cap portion and said substantially concave portion, when attached, define an internal space having a substantially hollow hemispherical shape.

12. The method according to claim 10 wherein said cap portion comprises a mandrel formed from a substantially rigid material.

13. The method according to claim 9 further comprising compacting said mold to form a green body comprising said metal powder.

14. A method comprising:
placing a metal powder into a substantially concave portion of a mold, wherein said mold further comprises a cap portion that is configured for removable attachment to said substantially concave portion and comprises a mandrel formed from a substantially rigid material; and,
compacting said mold to form a green body comprising said metal powder.

15. The method according to claim 14 wherein said metal powder is placed into said substantially concave portion of said mold prior to attachment of said cap portion to said substantially concave portion, and further comprising attaching said cap portion to said substantially concave portion prior to compacting said mold.

16. The method according to claim 14 wherein said metal powder is placed into said substantially concave portion of said mold while said cap portion is attached to substantially concave portion.

17. The method according to claim 16 wherein said metal powder is placed into said substantially concave portion of said mold through an opening in said substantially concave portion.

18. The method according to claim 14 wherein said cap portion and said substantially concave portion, when attached, define an internal space having a three-dimensional shape.

19. The method according to claim 18 wherein said cap portion and said substantially concave portion, when attached, define an internal space having a substantially hollow hemispherical shape.
